(19) United States
(12) Patent Application Publication
(10) Pub. No.: US 2016/0282560 A1
(43) Pub. Date: Sep. 29, 2016

(54) OPTICAL DEMULTIPLEXING APPARATUS AND METHOD FOR MULTI-CARRIER DISTRIBUTION

(71) Applicant: ELECTRONICS AND TELECOMMUNICATIONS RESEARCH INSTITUTE, Daejeon-si (KR)

(72) Inventors: Joon Young HUH, Daejeon-si (KR); Sun Hyok CHANG, Daejeon-si (KR); Hwan Seok CHUNG, Daejeon-si (KR)

(21) Appl. No.: 15/081,267

(22) Filed: Mar. 25, 2016

(30) Foreign Application Priority Data
Mar. 25, 2015 (KR) 10-2015-0041726

(51) Int. Cl. G02B 6/293; H04L 25/14

(52) U.S. Cl. CPC G02B 6/2938; H04L 25/14; G02B 6/29386; G02B 6/29316; H04J 14/02

(57) ABSTRACT

An optical demultiplexing apparatus and method for multi-carrier distribution are provided. The optical demultiplexing apparatus may include a demultiplexer and a carrier distributor. The optical demultiplexing apparatus and method allow efficient demultiplexing of a multi-carrier light source by using a single demultiplexer even when a carrier spacing of the light source varies.

### CROSS REFERENCE TO RELATED APPLICATION

This application claims priority from Korean Patent Application No. 10-2015-0041726, filed on Mar. 25, 2015, in the Korean Intellectual Property Office, the disclosure of which is incorporated herein by reference in its entirety.

### BACKGROUND

1. Field

The following description relates to an optical demultiplexing apparatus and method for multi-carrier distribution, and more particularly, to an apparatus and method for effectively distributing multi-carrier optical signal used in an optical communication system.

2. Description of Related Art

In order to achieve advanced, flexible, and smart long-distance optical transmission networks, a multi-carrier light source technology is required in a flexible optical transceiver that flexibly adjusts transmission capacity, thereby allowing for efficient use, re-distribution and services of the transmission capacity.

This is because frequency spacing of carriers of a multi-carrier light source can be adjusted according to a frequency of a radio frequency (RF) clock used in generating the light source.

In the multi-carrier light source technology, distribution of multi carriers is required to demodulate said multi carriers. However, design and production of an optical demultiplexing apparatus whose channel spacing is tunable have been a challenge not only from technical and economical perspectives but also from a size perspective.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description is to provide an optical demultiplexing apparatus and method for efficiently demultiplexing a multi-carrier light source by using only a single optical demultiplexer even when a carrier spacing varies.

In one general aspect, there is provided an optical demultiplexing apparatus including: a demultiplexer configured to demultiplex a received multi-carrier light source according to a predesignated period; and a carrier distributor configured to, in a case where a wavelength spacing of the demultiplexed multi-carrier light source is set to be space S1 or space S2, which is greater than space S1, and the wavelength spacing can be switched between space S1 and space S2, determine an output wavelength spacing and bandwidth of output ports based on information about space S1 and space S2, and distribute carriers of the demultiplexed multi-carrier light source based on the calculated output wavelength spacing and bandwidth, such that the output ports are disposed to have the calculated wavelength spacing and a wavelength of a respective carrier is located within the calculated bandwidth of a respective output port.

In a case where two carriers are included in the multi-carrier light source and two output ports are provided, the carrier distributor may determine the output wavelength spacing ΔF between the two output ports and the bandwidth BW of the output ports, both of which satisfy (ΔF−BR)≦S1≦(ΔF+BW) and (3×ΔF−BW)≦S2≦(3×ΔF+BW), where ΔF represents the output wavelength spacing of the output ports, BW denotes the bandwidth of the output port, S1 represents space S1 and S2 represents space S2.

In a case where two carriers are included in the multi-carrier light source, two output ports are provided, and S2 is four times or more greater than S1, the carrier distributor may determine the output wavelength spacing ΔF between the two output ports and the bandwidth BW of the output ports, both of which satisfy (ΔF−BW)≦S1≦(ΔF+BW) and (5×ΔF−BW)≦S2≦(5×ΔF+BW), where ΔF represents the output wavelength spacing of the output ports, BW denotes the bandwidth of the output port, S1 represents space S1 and S2 represents space S2.

In a case where three carriers are included in the multi-carrier light source and three output ports are provided, the carrier distributor may determine the output wavelength spacing ΔF between the two output ports and the bandwidth BW of the output ports, both of which satisfy (2×ΔF−BW)≦2×S1≦(2×ΔF+BW) and (4×ΔF−BW)≦2×S2≦(4×ΔF+BW), where ΔF represents the output wavelength spacing of the output ports, BW denotes the bandwidth of the output port, S1 represents space S1 and S2 represents space S2.

In a case where four carriers are included in the multi-carrier light source and four output ports are provided, the carrier distributor may determine the output wavelength spacing ΔF between the two output ports and the bandwidth BW of the output ports, both of which satisfy (3×ΔF−BW)≦3×S1≦(3×ΔF+BW) and (2×ΔF−BW)≦S2≦(ΔF+BW), where ΔF represents the output wavelength spacing of the output ports, BW denotes the bandwidth of the output port, S1 represents space S1 and S2 represents space S2.

In a case where m number of carriers are included in the multi-carrier light source and m number of output ports are provided, the carrier distributor may determine the output wavelength spacing ΔF between the two output ports and the bandwidth BW of the output ports, both of which satisfy (m−1)×(m×k−p)ΔF−BW≦(m−1)×S≦(m−1)×(m×k−p)×ΔF−BW, where p is a natural number that is smaller than m, ΔF represents the output wavelength spacing of the output ports, BW denotes the bandwidth of the output port, and S denotes a space.

In another general aspect, there is provided an optical demultiplexing method for multi-carrier distribution by using frequency adjustment, the optical demultiplexing method including: demultiplexing a received multi-carrier light source according to a predesignated period; and in a case where a wavelength spacing of the demultiplexed multi-carrier light source is set to be space S1 or space S2, which is greater than space S1, and the wavelength spacing can be switched between space S1 and space S2, determining an output wavelength spacing and bandwidth of output ports based on information about space S1 and space S2, designing the output ports to have the calculated wavelength spacing and to allow a wavelength of a respective carrier to be located within the calculated bandwidth of a respective output port, and distributing carriers of the demultiplexed multi-carrier light source.

In a case where two carriers are included in the multi-carrier light source and two output ports are provided, the distribution of the carriers of the demultiplexed multi-carrier light source may include determining the output wavelength spacing ΔF between the two output ports and the bandwidth BW of the output ports, both of which satisfy (ΔF−BW)≦S1≦(ΔF+BW) and (3×ΔF−BW)≦S2≦(3×ΔF+BW), where ΔF represents the output wavelength spacing of the output ports, BW denotes the bandwidth of the output port, S1 represents space S1 and S2 represents space S2.

In a case where two carriers are included in the multi-carrier light source, two output ports are provided, and S2 is four times or more greater than S1, the distribution of the carriers of the demultiplexed multi-carrier light source may include determining the output wavelength spacing ΔF between the two output ports and the bandwidth BW of the output ports, both of which satisfy (ΔF−BW)≦S1≦(ΔF+BW) and (5×ΔF−BW)≦S2≦(5×ΔF+BW), where ΔF represents the output wavelength spacing of the output ports, BW denotes the bandwidth of the output port, S1 represents space S1 and S2 represents space S2.

In a case where three carriers are included in the multi-carrier light source and three output ports are provided, the distribution of the carriers of the demultiplexed multi-carrier light source may include determining the output wavelength spacing ΔF between the two output ports and the bandwidth BW of the output ports, both of which satisfy (2×ΔF−BW)≦2×S1≦(2×ΔF+BW) and (4×ΔF−BW)≦2×S2≦(4×ΔF+BW), where ΔF represents the output wavelength spacing of the output ports, BW denotes the bandwidth of the output port, S1 represents space S1 and S2 represents space S2.

In a case where four carriers are included in the multi-carrier light source and four output ports are provided, the distribution of the carriers of the demultiplexed multi-carrier light source may include determining the output wavelength spacing ΔF between the two output ports and the bandwidth BW of the output ports, both of which satisfy (3×ΔF−BW)≦3×S1≦(3×ΔF+BW) and (2×ΔF−BW)≦S2≦(ΔF+BW), where ΔF represents the output wavelength spacing of the output ports, BW denotes the bandwidth of the output port, S1 represents space S1 and S2 represents space S2.

In a case where in number of carriers are included in the multi-carrier light source and m number of output ports are provided, the distribution of the carriers of the demultiplexed multi-carrier light source may include determining the output wavelength spacing ΔF between the two output ports and the bandwidth BW of the output ports, both of which satisfy (m−1)×(m×k−p) ΔF−BW≦(m−1)×S≦(m−1)×(m×k−p)×ΔF−BW, where p is a natural number that is smaller than m, ΔF represents the output wavelength spacing of the output ports, BW denotes the bandwidth of the output port, and S denotes a space.

Other features and aspects will be apparent from the following detailed description, the drawings, and the claims.

### BRIEF DESCRIPTION OF THE DRAWINGS

FIG. 1 is a diagram illustrating an optical demultiplexing apparatus that adjusts frequencies for multi-carrier distribution.

FIG. 2A illustrates a graph showing an output wavelength spacing and bandwidth of output ports of an optical demultiplexing apparatus in the case where a carrier frequency spacing is S1 when the optical demultiplexing apparatus has two carriers and two output ports according to an exemplary embodiment.

FIG. 2B illustrates a graph showing an output wavelength spacing and bandwidth of output ports of an optical demultiplexing apparatus in the case where a carrier frequency spacing is S2 when the optical demultiplexing apparatus has two carriers and two output ports according to an exemplary embodiment.

FIG. 3A illustrates a graph showing an output wavelength spacing and bandwidth of output ports of an optical demultiplexing apparatus in the case where a carrier frequency spacing is S1, which is significantly smaller than the other possible carrier frequency spacing, when the optical demultiplexing apparatus has two carriers and two output ports according to an exemplary embodiment.

FIG. 3B illustrates a graph showing an output wavelength spacing and bandwidth of output ports of an optical demultiplexing apparatus in the case where a carrier frequency spacing is S2 which is significantly greater than the other possible carrier frequency spacing, when the optical demultiplexing apparatus has two carriers and two output ports according to an exemplary embodiment.

FIG. 4A is a graph showing an output wavelength spacing and bandwidth of output ports of an optical demultiplexing apparatus in the case where a carrier frequency spacing is S1 when the optical demultiplexing apparatus has three carriers and three output ports according to an exemplary embodiment.

FIG. 4B is a graph showing an output wavelength spacing and bandwidth of output ports of an optical demultiplexing apparatus in the case where a carrier frequency spacing is S2 when the optical demultiplexing apparatus has three carriers and three output ports according to an exemplary embodiment.

FIG. 5A is a graph showing an output wavelength spacing and bandwidth of output ports of an optical demultiplexing apparatus in the case where a carrier frequency spacing is S1 when the optical demultiplexing apparatus has three carriers and three output ports according to an exemplary embodiment.

FIG. 5B illustrates a graph showing an output wavelength spacing and bandwidth of output ports of an optical demultiplexing apparatus in the case where a carrier frequency spacing is S2 when the optical demultiplexing apparatus has three carriers and three output ports according to an exemplary embodiment.

FIG. 6 is a flowchart illustrating an optical demultiplexing method that adjusts frequencies for multi-carrier distribution according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, an apparatus and method for distributing a multi-carrier light source by adjusting frequencies will be described with reference to the accompanying drawings.

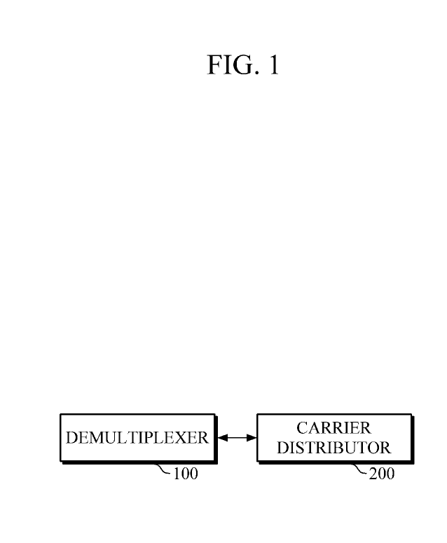

FIG. 1 is a diagram illustrating an optical demultiplexing apparatus that adjusts frequencies for multi-carrier distribution.

Referring to FIG. 1, an optical demultiplexing apparatus 1000 that adjusts frequencies for multi-carrier distribution may include a demultiplexer 100 and a carrier distributor 200.

The demultiplexer 100 may receive a multi-carrier light source and demultiplex the multi-carrier light source according to a predetermined period.

The multi-carrier light source may be demultiplexed in the reverse order of multiplexing. According to the exemplary embodiment, a wavelength-division multiplexing (WDM) technology may be used; however, aspects of the present disclosure are not limited thereto, and any methods may be used as long as they multiplex and demultiplex the multi-carrier light source.

In the case where a wavelength spacing of the demultiplexed multi-carrier light source is set to be space S1 or space S2, which is greater than space S1, and the wavelength spacing can be switched between space S1 and space S2, an output wavelength spacing between output ports and a bandwidth of the output ports are calculated based on information regarding space S1 and space S2. The carrier distributor 200 may distribute carriers of the demultiplexed multi-carrier light source based on the calculated output wavelength spacing and bandwidth, such that the output ports are disposed to have the calculated wavelength spacing and a wavelength of a respective carrier can be located within the calculated bandwidth of a respective output port.

According to the exemplary embodiment, a wavelength spacing of the multi-carrier light source may be adjusted to be space S1 or space S2, where space S2 is defined to be greater than space S1.

The wavelength spacing may be adjusted to space S1 or space S2 by adjusting a frequency of a radio frequency (RF) clock signal, but aspects of the present disclosure are not limited thereto.

Once space S1 and space S2 have been determined, an output wavelength spacing ΔF of output ports and a bandwidth (BW) of each output port may be calculated according to the number of carriers included in the multi-carrier light source received by the optical multiplexer 1000 and the number of output ports.

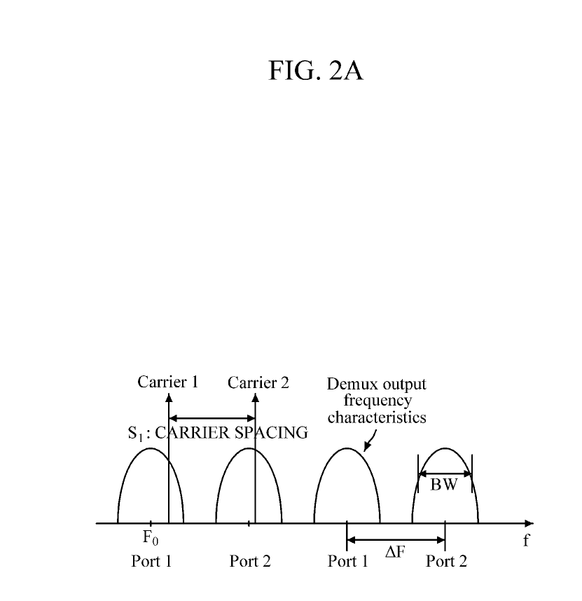

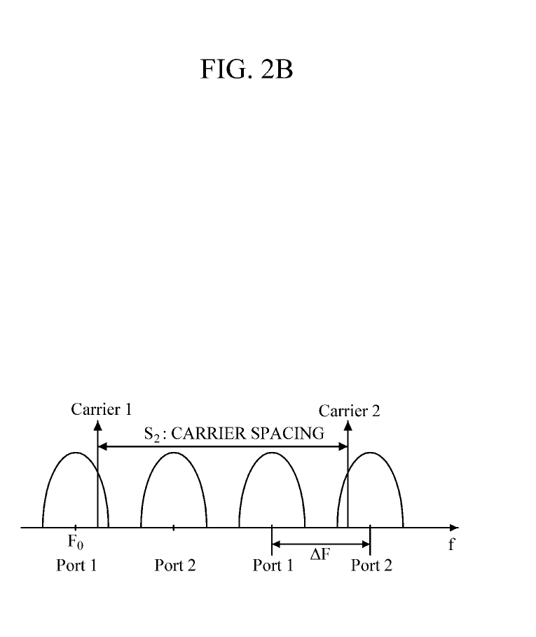

Methods for calculating the output wavelength spacing ΔF of the output ports and the bandwidth of each output port will be described in detail with reference to FIGS. 2A to 5B.

The optical demultiplexing apparatus 100 may be designed to include output ports which have the output wavelength spacing ΔF as calculated above and to have a periodicity such that a wavelength of each carrier of the multi-carrier light source is located at the bandwidth of each output port, and thereby the demultiplexed multi-carriers can be distributed.

The above optical demultiplexing apparatus 1000 may efficiently distribute multi-carriers which have a channel spacing that varies while the output ports are being connected to each other.

In this case, better performance may be achieved if a wavelength of a seed light source is tuned or the center wavelength of the optical demultiplexing apparatus that has a periodicity is tuned, according to an output carrier.

Here, the wavelength tuning is merely fine adjustment that is carried out within a bandwidth of the optical demultiplexing apparatus, and thus it does not have significant influence on the system.

According to the exemplary embodiment, the optical demultiplexing apparatus with a periodicity may include an interleaver and arrayed waveguide grating (AWG), but aspects of the present disclosure are not limited thereto.

FIG. 2A illustrates a graph showing an output wavelength spacing and bandwidth of output ports of an optical demultiplexing apparatus in the case where a carrier frequency spacing is S1 when the optical demultiplexing apparatus has two carriers and two output ports according to an exemplary embodiment.

Referring to FIG. 2A, an output wavelength spacing ΔF of output ports of the optical demultiplexing apparatus may be set to be from space S1 to space S2.

In order to enable the two carriers of the optical demultiplexing apparatus that have space S1 to be efficiently output, a wavelength of a respective carrier needs to be located within a bandwidth (BW) of a respective port, as shown in FIG. 2A.

Conditions for locating the wavelengths of carriers as shown in FIG, 2A are as follows:

(ΔF−B.W)≦S1≦(ΔF+B.W) (1)

An output wavelength spacing and a bandwidth of each output port may be determined based on Formula 1 as above and Formula 2 which will be described below.

According to the exemplary embodiment, both the output wavelength spacing and the bandwidth of each output port that satisfy Formulas 1 and 2 are determined as the description above, and the periodical optical demultiplexing apparatus may be designed based on the determined output wavelength spacing and bandwidth of the output port.

FIG. 2B illustrates a graph showing an output wavelength spacing and bandwidth of output ports of an optical demultiplexing apparatus in the case where a carrier frequency spacing is S2 when the optical demultiplexing apparatus has two carriers and two output ports according to an exemplary embodiment.

Referring to FIG. 2B, when the two carriers with space S2, which is greater than space S1, are located as shown in FIG. 2B, they can be output through the respective output ports, like in the case where the carrier frequency spacing is S1.

Conditions for achieving the above result are as follows:

(3×ΔF−B.W)≦S2≦(3×ΔF+B.W) (2)

As described above, the output wavelength spacing and bandwidth of the output ports that satisfy Formula 1 and Formula 2 may be determined.

According to the exemplary embodiment, the periodical optical demultiplexing apparatus 1000 is designed to have the output wavelength spacing and the wavelength of output ports as described above, and the multiple carriers which have a channel spacing that varies while the output ports are being connected to each other can be effectively distributed by using the single periodical optical demultiplexing apparatus.

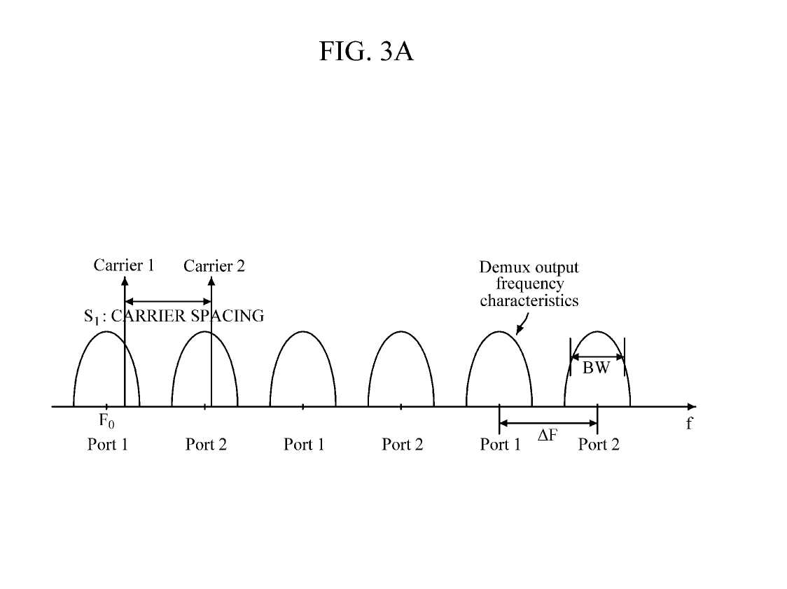

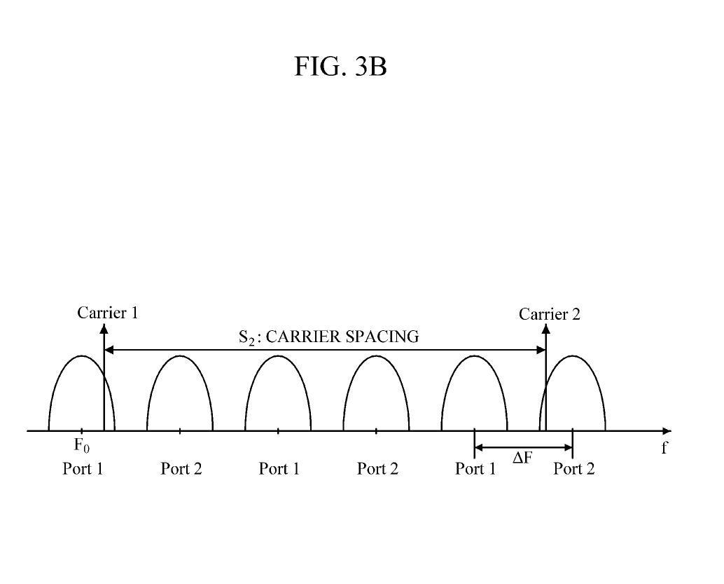

FIG. 3A illustrates a graph showing an output wavelength spacing and bandwidth of output ports of an optical demultiplexing apparatus in the case where a carrier frequency spacing is S1, which is significantly smaller than the other possible carrier frequency spacing, when the optical demultiplexing apparatus has two carriers and two output ports according to an exemplary embodiment.

Referring to FIG. 3A, an output wavelength spacing ΔF of the two output ports of the optical demultiplexing apparatus may be set to be from space S1 to space S2.

In order to enable the two carriers of the optical demultiplexing apparatus that have space S1 to be efficiently output, a wavelength of a respective carrier needs to be located within a bandwidth (BW) of a respective port, as shown in FIG. 3A.

In the present exemplary embodiment, space S2 may be four times or more greater than space S1.

Conditions for locating the wavelengths of carriers as shown in FIG. 3A are as follows:

(ΔF−B.W)≦S1≦(ΔF+B.W) (5)

An output wavelength spacing and a bandwidth of each output port may be determined based on Formula 3 as above and Formula 4 which will be described below.

According to the exemplary embodiment, both the output wavelength spacing and the bandwidth of each output port that satisfy said two formulas are determined as the description above, and the periodical optical demultiplexing apparatus may be designed based on the determined output wavelength spacing and bandwidth of the output port.

FIG. 3B illustrates a graph showing an output wavelength spacing and bandwidth of output ports of an optical demultiplexing apparatus in the case where a carrier frequency spacing is S2 which is significantly greater than the other possible carrier frequency spacing, when the optical demultiplexing apparatus has two carriers and two output ports according to an exemplary embodiment.

Referring to FIG. 3B, when the two carriers with space S2, which is greater than space S1, are located as shown in FIG. 3B, they can be output through the respective output ports, like in the case where the carrier frequency spacing is S1.

Conditions for achieving the above result are as follows:

(5×ΔF−B.W)≦S2≦(5×ΔF+B.W) (4)

As described above, the output wavelength spacing and bandwidth of the output ports that satisfy Formula 3 and Formula 4 may be determined.

In the present exemplary embodiment, space S2 may be four times or more greater than space S1.

According to the exemplary embodiment, the periodical optical demultiplexing apparatus 1000 is designed to have the output wavelength spacing and the wavelength of output ports as described above, and the multiple carriers which have a channel spacing that varies while the output ports are being connected to each other can be effectively distributed by using the single periodical optical demultiplexing apparatus.

Based on FIGS, 2A to 3B, the output wavelength spacing and bandwidth of the two output ports may be derived as follows:

((2n−1)×ΔF−B.W)≦S≦((2n−1)×ΔF+B.W) (5)

where n is a natural number that can be changed by user's setting.

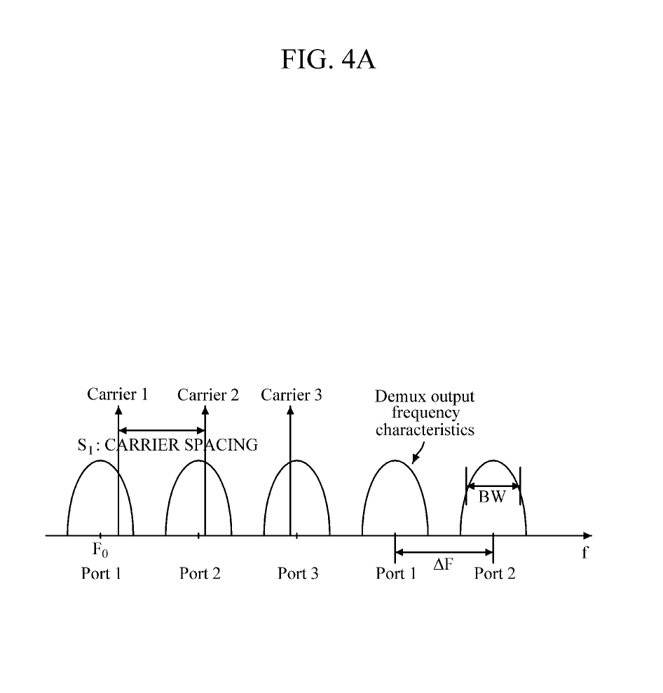

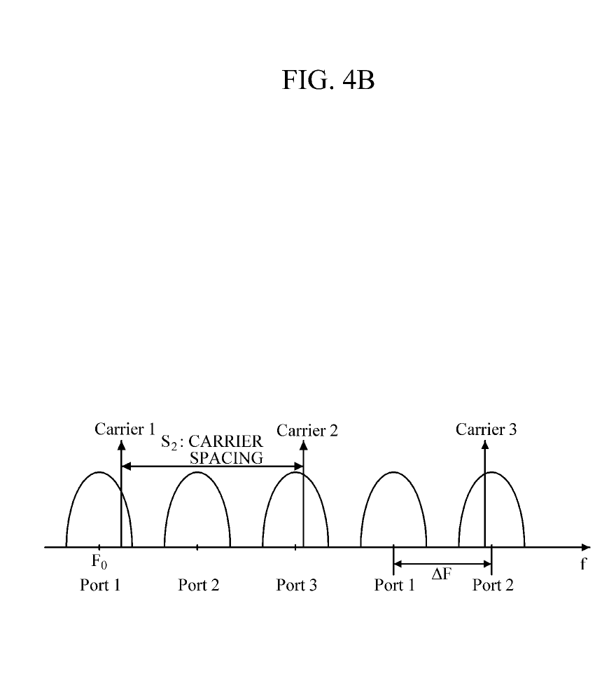

FIG. 4A is a graph showing an output wavelength spacing and bandwidth of output ports of an optical demultiplexing apparatus in the case where a carrier frequency spacing is S1 when the optical demultiplexing apparatus has three carriers and three output ports according to an exemplary embodiment.

In order to enable the three carriers of the optical demultiplexing apparatus that have space S1 to be efficiently output, a wavelength of a respective carrier needs to be located within a bandwidth (BW) of a respective port, as shown in FIG. 4A.

Conditions for locating the wavelengths of carriers as shown in FIG. 4A are as follows:

(2×ΔF−B.W)≦2×S1≦(2×ΔF+B.W) (6)

An output wavelength spacing and a bandwidth of each output port may be determined based on Formula 6 and Formula 7 which will be described below.

According to the exemplary embodiment, the output wavelength spacing and the bandwidth of output ports that satisfy said two formulas may be determined as the description above, and the periodical optical demultiplexing apparatus may be designed based on the determined output wavelength spacing and bandwidth of the output ports.

FIG. 4B is a graph showing an output wavelength spacing and bandwidth of output ports of an optical demultiplexing apparatus in the case where a carrier frequency spacing is S2 when the optical demultiplexing apparatus has three carriers and three output ports according to an exemplary embodiment.

When two carriers out of the three carriers that have an space S2, which is greater than space S1, are located as shown in FIG. 4B, they can be output, respectively, through two of the three output ports, like in the case where the carrier frequency spacing is S1.

Conditions for achieving the above result are as follows:

(5×ΔF−B.W)≦2×S2≦(5×ΔF+B.W) (7)

As described above, the output wavelength spacing and bandwidth of the output ports that satisfy Formula 6 and Formula 7 may be determined.

Based on FIGS. 4A and 4B, the output wavelength spacing and the bandwidth of each of the three output ports can be derived as follows:

2×(3n−1)×ΔF−B.W≦2×S≦2×(3n−1)×ΔF+B.W

2×(3n−1)×ΔF−B.W≦2×S≦2×(3n−1)×ΔF+B.W (8)

,where n is a natural number, which may be changed by user's setting.

According to the exemplary embodiment, the periodical optical demultiplexing apparatus 1000 is designed to have the output wavelength spacing and the wavelength of output ports as described above, and the multiple carriers which have a channel spacing that varies while the output ports are being connected to each other can be effectively distributed by using the single periodical optical demultiplexing apparatus.

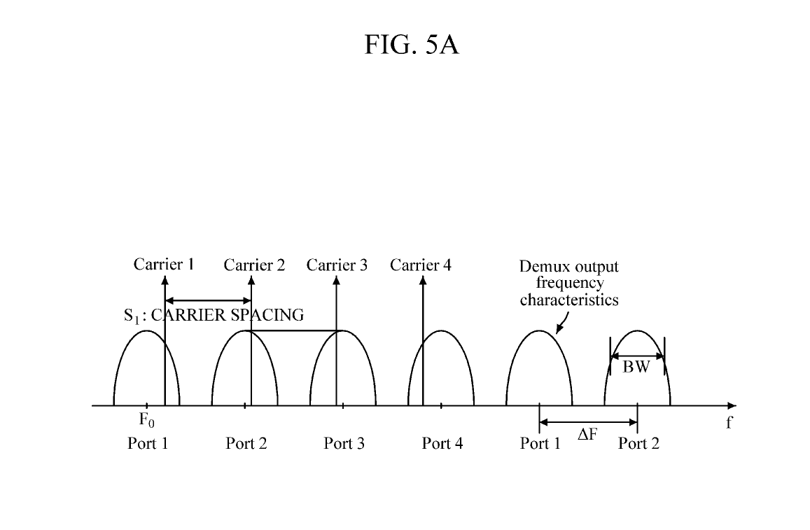

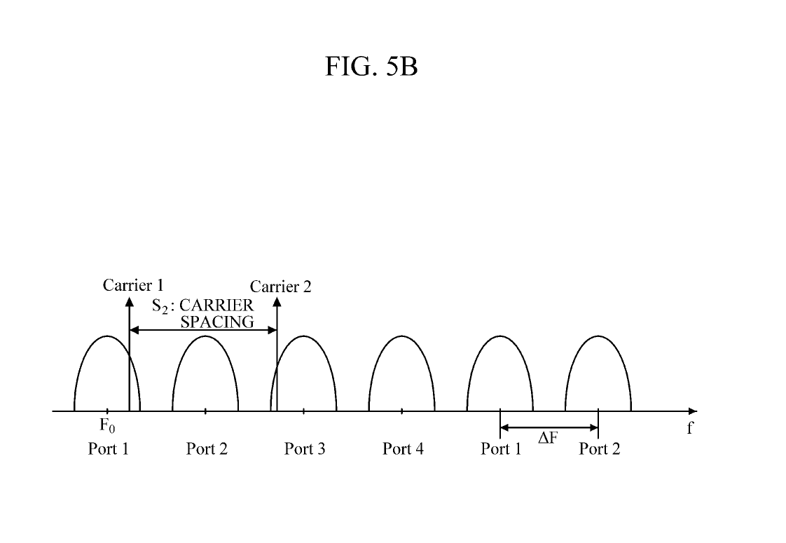

FIG. 5A is a graph showing an output wavelength spacing and bandwidth of output ports of an optical demultiplexing apparatus in the case where a carrier frequency spacing is S1 when the optical demultiplexing apparatus has three carriers and three output ports according to an exemplary embodiment.

In order to enable the four carriers of the optical demultiplexing apparatus with space S1 to be efficiently output, a wavelength of a respective carrier needs to be located within a bandwidth (BW) of a respective port, as shown in FIG. 5A.

Conditions for locating the wavelengths of carriers as shown in FIG. 4A are as follows:

(3×ΔF−B.W)≦3×S123 (3×ΔF+B.W) (9)

An output wavelength spacing and a bandwidth of each output port may be determined based on Formula 9 and Formula 10 which will be described below.

According to the exemplary embodiment, the output wavelength spacing and the bandwidth of output ports that satisfy said two formulas may be determined as the description. above, and the periodical optical demultiplexing apparatus may be designed based on the determined output wavelength spacing and bandwidth of the output ports.

FIG. 5B illustrates a graph showing an output wavelength spacing and bandwidth of output ports of an optical demultiplexing apparatus in the case where a carrier frequency spacing is S2 when the optical demultiplexing apparatus has three carriers and three output ports according to an exemplary embodiment.

When two out of the four carriers that have space S2, which is greater than space S1, are located as shown in FIG. 5B, they can be output, respectively, through two of the four output ports, like in the case where the carrier frequency spacing is S1.

Conditions for achieving the above result are as follows:

(2×ΔF−B.W)≦S2≦(ΔF+B.W) (10)

As described above, the output wavelength spacing and bandwidth of output ports that satisfy Formula 9 and Formula 10 may be determined.

Based on FIGS. 5A and 5B, the output wavelength spacing and the bandwidth of the three output ports can be derived as follows:

3×(4n−1)×ΔF−B.W≦3×S≦3×(4n−1)×ΔF+B.W

3×(4n−2)×ΔF−B.W≦3×S≦3×(4n−2)×ΔF+B.W or,

3×(4n−3)×ΔF−B.W≦3×S≦3×(4n−3)×ΔF+B.W (11)

, where n is a natural number, which may be changed by user's setting.

According to the exemplary embodiment, the periodical optical demultiplexing apparatus 1000 is designed to have the output wavelength spacing and the wavelength of output ports as described above, and the multiple carriers which have a channel spacing that varies while the output ports are being connected to each other can be effectively distributed by using the single periodical optical demultiplexing apparatus.

Also, according to the exemplary embodiment, given that m is the number of output ports, p is a natural number that is smaller than m, the following formula is derived:

(m−1)×(m×k−p)×ΔF−B.W≦(m−1)×S≦(m−1)×(m×k−p)×ΔF−B.W (12)

In the case where four or more even number of output ports are provided, the following formula can be derived:

(m/2)×ΔF−B.W≦S≦(m/2−1)×ΔF×ΔF−B.W (13)

In addition, in the case where eight or more even number of output ports are provided, the following formula can be derived:

(m/4)×ΔF−B.W≦S≦(m/4−1)×ΔF×ΔF−B.W (14)

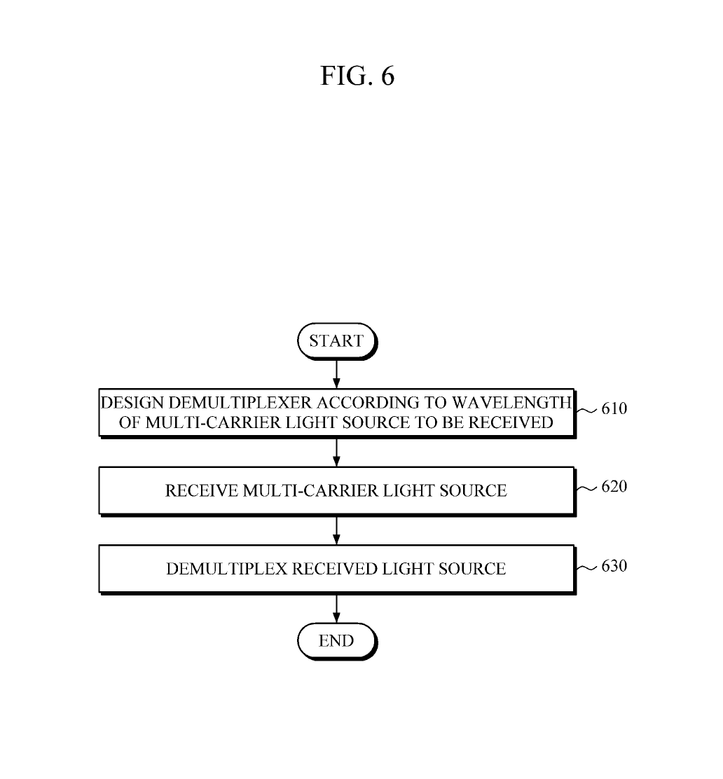

FIG. 6 is a flowchart illustrating an optical demultiplexing method that adjusts frequencies for multi-carrier distribution according to an exemplary embodiment,

In 610, a demultiplexer is designed according to a wavelength of a multi-carrier light source to be received.

According to the exemplary embodiment, a wavelength spacing of multiple carriers of the light source to be received may be set to either space S1 or space S2, which is greater than space S1, and if the wavelength spacing can be switched between space S1 and space S2, an output wavelength spacing of output ports and a bandwidth of each output port are calculated based on information about said two spaces. Then, the demultiplexer may be designed based on the calculated output wavelength spacing and bandwidth, such that a wavelength of a respective carrier can be located within the calculated bandwidth of a respective output port.

In this case, the method for calculating the output wavelength spacing and the bandwidth of the output ports may vary according to the number of carriers of the multi-carrier light source and the number of output ports included in the optical demultiplexing apparatus.

In the case where two carriers are generated from a multi-carrier light source and the optical demultiplexing apparatus has two output ports, the output wavelength spacing and the bandwidth of the output port may be determined to satisfy conditions defined in Formula 1 and Formula 2.

In the case where two carriers are generated from a multi-carrier light source, the optical demultiplexing apparatus has two output ports, and one of possible carrier spaces is significantly great, the output wavelength spacing and the bandwidth of the output port may be determined to satisfy conditions defined in Formula 3 and Formula 4.

In the case where three carriers are generated from a multi-carrier light source and the optical demultiplexing apparatus has three output ports, the output wavelength spacing and the bandwidth of the output port may be determined to satisfy conditions defined in Formula 5 and Formula 6.

In the case where four carriers are generated from a multi-carrier light source and the optical demultiplexing apparatus has four output ports, the output wavelength spacing and the bandwidth of the output port may be determined to satisfy conditions defined in Formula 7 and Formula 8.

The multi-carrier light source is received, as depicted in 620.

According to the exemplary embodiment, the received light source may be a light source that has been optically multiplexed.

The received light source is demultiplexed, as depicted in 630.

The multi-carrier light source may be demultiplexed in the reverse order of multiplexing. According to the exemplary embodiment, a wavelength-division multiplexing (WDM) technology may be used; however, aspects of the present disclosure are not limited thereto, and any methods may be used as long as they multiplex and demultiplex the multi-carrier light source.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical demultiplexing apparatus comprising:
a demultiplexer configured to demultiplex a received multi-carrier light source according to a predesignated period; and
a carrier distributor configured to, in a case where a wavelength spacing of the demultiplexed multi-carrier light source is set to be space S1 or space S2, which is greater than space S1, and the wavelength spacing can be switched between space S1 and space S2, determine an output wavelength spacing and bandwidth of output ports based on information about space S1 and space S2, and distribute carriers of the demultiplexed multi-carrier light source based on the calculated output wavelength spacing and bandwidth, such that the output ports are disposed to have the calculated wavelength spacing and a wavelength of a respective carrier is located within the calculated bandwidth of a respective output port.

2. The optical demultiplexing apparatus of claim 1, wherein in a case where two carriers are included in the multi-carrier light source and two output ports are provided, the carrier distributor determines the output wavelength spacing ΔF between the two output ports and the bandwidth BW of the output ports, both of which satisfy (ΔF−BW)≦S1≦(ΔF+BW) and (3×ΔF−BW)≦S2≦(3×ΔF+BW), where ΔF represents the output wavelength spacing of the output ports, BW denotes the bandwidth of the output port, S1 represents space S1 and S2 represents space S2.

3. The optical demultiplexing apparatus of claim 1, wherein in a case where two carriers are included in the multi-carrier light source, two output ports are provided, and S2 is four times or more greater than S1, the carrier distributor determines the output wavelength spacing ΔF between the two output ports and the bandwidth BW of the output ports, both of which satisfy (ΔF−BW)≦S1≦(ΔF+BW) and (5×ΔF−BW)≦S2≦(5×ΔF+BW), where ΔF represents the output wavelength spacing of the output ports, BW denotes the bandwidth of the output port, S1 represents space S1 and S2 represents space S2.

4. The optical demultiplexing apparatus of claim 1, wherein in a case where three carriers are included in the multi-carrier light source and three output ports are provided, the carrier distributor determines the output wavelength spacing ΔF between the two output ports and the bandwidth BW of the output ports, both of which satisfy (2×ΔF−BW)≦2×S1≦(2×ΔF+BW) and (4×ΔF−BW)≦2×S2≦(4×ΔF+BW), where ΔF represents the output wavelength spacing of the output ports, BW denotes the bandwidth of the output port, S1 represents space S1 and S2 represents space S2.

5. The optical demultiplexing apparatus of claim 1, wherein in a case where four carriers are included in the multi-carrier light source and four output ports are provided, the carrier distributor determines the output wavelength spacing ΔF between the two output ports and the bandwidth BW of the output ports, both of which satisfy (3×ΔF−BW)≦3×S1≦(3×ΔF+BW) and (2×ΔF−BW)≦S2≦(ΔF+BW), where ΔF represents the output wavelength spacing of the output ports, BW denotes the bandwidth of the output port, S1 represents space S1 and S2 represents space S2.

6. The optical demultiplexing apparatus of claim 1, wherein in a case where m number of carriers are included in the multi-carrier light source and m number of output ports are provided, the carrier distributor determines the output wavelength spacing ΔF between the two output ports and the bandwidth BW of the output ports, both of which satisfy (m−1)×(m×k−p) ΔF−BW≦(m−1)×S≦(m−1)×(m×k−p)×ΔF−BW, where p is a natural number that is smaller than m, ΔF represents the output wavelength spacing of the output ports, BW denotes the bandwidth of the output port, and S denotes a space.

7. An optical demultiplexing method for multi-carrier distribution by using frequency adjustment, the optical demultiplexing method comprising:
demultiplexing a received multi-carrier light source according to a predesignated period; and
in a case where a wavelength spacing of the demultiplexed multi-carrier light source is set to be space S1 or space S2, which is greater than space S1, and the wavelength spacing can be switched between space S1 and space S2, determining an output wavelength spacing and bandwidth of output ports based on information about space S1 and space S2, designing the output ports to have the calculated wavelength spacing and to allow a wavelength of a respective carrier to be located within the calculated bandwidth of a respective output port, and distributing carriers of the demultiplexed multi-carrier light source.

8. The optical demultiplexing method of claim 7, wherein in a case where two carriers are included in the multi-carrier light source and two output ports are provided, the distribution of the carriers of the demultiplexed multi-carrier light source comprises determining the output wavelength spacing ΔF between the two output ports and the bandwidth BW of the output ports, both of which satisfy (ΔF−BW) ≦S1≦(ΔF+BW) and (3×ΔF−BW)≦S2≦(3×ΔF+BW), where ΔF represents the output wavelength spacing of the output ports, BW denotes the bandwidth of the output port, S1 represents space S1 and S2 represents space S2.

9. The optical demultiplexing method of claim 7, wherein in a case where two carriers are included in the multi-carrier light source, two output ports are provided, and S2 is four times or more greater than S1, the distribution of the carriers of the demultiplexed multi-carrier light source comprises determining the output wavelength spacing ΔF between the two output ports and the bandwidth BW of the output ports, both of which satisfy (ΔF−BW)≦S1≦(ΔF−BW) and (5×ΔF−BW)≦S2≦(5×ΔF+BW), where ΔF represents the output wavelength spacing of the output ports, BW denotes the bandwidth of the output port, S1 represents space S1 and S2 represents space S2.

10. The optical demultiplexing method of claim 7, wherein in a case where three carriers are included in the multi-carrier light source and three output ports are provided, the distribution of the carriers of the demultiplexed multi-carrier light source comprises determining the output wavelength spacing ΔF between the two output ports and the bandwidth BW of the output ports, both of which satisfy (2×ΔF−BW)≦2×S1≦(2×ΔF+BW) and (4×ΔF−BW)≦2×S2≦(4×ΔF+BW), where ΔF represents the output wavelength spacing of the output ports, BW denotes the bandwidth of the output port, S1 represents space S1 and S2 represents space S2.

11. The optical demultiplexing method of claim 7, wherein in a case where four carriers are included in the multi-carrier light source and four output ports are provided, the distribution of the carriers of the demultiplexed multi-carrier light source comprises determining the output wavelength spacing ΔF between the two output ports and the bandwidth BW of the output ports, both of which satisfy (3×ΔF−BW)≦3×S1≦(3×ΔF+BW) and (2×ΔF−BW)≦S2≦(ΔF+BW), where ΔF represents the output wavelength spacing of the output ports, BW denotes the bandwidth of the output port, S1 represents space S1 and S2 represents space S2.

12. The optical demultiplexing method of claim 7, wherein in a case where m number of carriers are included in the multi-carrier light source and m number of output ports are provided, the distribution of the carriers of the demultiplexed multi-carrier light source comprises determining the output wavelength spacing ΔF between the two output ports and the bandwidth BW of the output ports, both of which satisfy (m−1)×(m×k−p)ΔF−BW≦(m−1)×S≦(m−1)×(m×k−p)×ΔF−BW, where p is a natural number that is smaller than m, ΔF represents the output wavelength spacing of the output ports, BW denotes the bandwidth of the output port, and S denotes a space.
